(19) United States
(12) Patent Application Publication
(10) Pub. No.: US 2026/0283214 A1
(43) Pub. Date: Sep. 24, 2026

(54) APPARATUS FOR ROASTING COFFEE BEANS

(71) Applicant: IKAWA Limited, London (GB)

(72) Inventors: Andrew STORDY, London (GB); Harry WELFARE, London (GB)

(21) Appl. No.: 19/476,542

(22) PCT Filed: Apr. 17, 2024
(86) PCT No.: PCT/EP2024/060396

§ 371 Date: Oct. 17, 2025

(30) Foreign Application Priority Data
Apr. 18, 2023 (GB) 2305682.3

(51) Int. Cl. A23N 12/12

(52) U.S. Cl. CPC A23N 12/125

(57) ABSTRACT

Apparatus (1) for roasting coffee beans, the apparatus comprising: a roast chamber (19) which a supply of coffee beans can be received for roasting; a heater (17) for heating air; a fan (21) for passing heated air through the roast chamber (19) to roast coffee beans received therein; a humidity sensor (31) operable to provide signals that are representative of the humidity of the heated air that has passed through the roast chamber (19); a temperature sensor (29) operable to provide signals that are representative of the air temperature within the roast chamber (19), and a control system (27) operable to control the apparatus (1), wherein said control system (27) is operable to determine that first crack has occurred in response to signals from said humidity sensor (31) and said temperature sensor (29).

### FIELD

This disclosure relates, in one aspect, to apparatus for roasting coffee beans. In one illustrative implementation of the teachings of this disclosure, the apparatus is configured as a sample roaster for roasting relatively small batches of coffee beans (typically less than 150 g), rather than the larger batches (typically 1 kg+) that are typically roasted in larger commercial coffee bean roasters. Implementations of the teachings of this disclosure can provide a table-top coffee-bean roaster that is well suited for home roasting in a domestic environment, or for test roasting small batches of green coffee beans before larger batches of the beans are roasted in a large-scale commercial roaster.

### BACKGROUND

Green coffee beans are typically roasted according to a “roast profile” to give the resulting brewed coffee a desired taste. Roast profiles typically set out the temperature at which the beans are roasted and the time for which the beans are roasted. In some instances, roast profiles can also define the speed of airflow through the roasting chamber. Some profiles may dictate that the beans are roasted at a roughly constant temperature for a particular period of time, whereas other roast profiles may vary the temperature throughout the roasting process.

Whilst the roasting of green coffee beans is an essentially technical process, it is nevertheless the case that varying degrees of artistry are employed to tailor the roasting profile to give brewed coffee (resulting from ground coffee formed by grinding roasted beans) a desired flavour and/or colour. It is also the case that roast profiles required to achieve a particular taste may vary between different types of coffee bean, from batch to batch of the same type of coffee bean, and if the moisture content of a batch of coffee beans has varied between roasts.

When green coffee beans are roasted they will reach a point, known in the art as the “first crack”, when the moisture in the bean expands and causes the bean to crack open, in a similar manner to the way that popping corn “pops” when heated. In the latter part of a dark roast, the beans will eventually reach a state, known as the “second crack”, when the coffee beans become oily. If roasting continues long after the second crack (the exact amount of time varying with the type of bean and the temperature of the roast), the beans will eventually ignite—which could pose a potentially serious safety risk.

An important indicator of the degree of roast and flavour is known as the “development time”, and is equal to the amount of time the roast continues after the first crack has occurred. The development time is often expressed as a ratio of the development time to the total roast time, referred to in the art as “the development time ratio”.

In an industrial environment, where persons are employed to monitor roasts, determining the point at which the first crack occurs and setting a desired development time are usually achievable for the coffee roasting professional. However, detecting the first crack is not always easy, even for coffee roasting professionals, as the sound of the crack tends to be a poor marker for the point at which the first crack occurs—some coffee beans crack less than others, and sometimes the point of first crack is not consistent for all the beans in a given sample. For persons without access to industrial equipment, for example a consumer roasting beans in a domestic environment, it would be beneficial for the operator of the roaster to be able to control the roast by setting a desired development time before the roast commences. Being able to control a roast in this way would also be beneficial in a commercial environment in circumstances where multiple small batches are being roasted, for example to see which roast profile is likely to be best for a larger roast in a commercial or industrial roaster, or to roast multiple samples of coffee for tasting before a purchasing decision is made.

In general terms, it would be beneficial if setting the development time for a given coffee bean roast could be made easier, thereby helping the less experienced and home users to more easily get good results. It would also be beneficial to provide experienced professionals with more information about a roast to increase their knowledge of the coffee and suggest how one might better roast a larger batch. The above notwithstanding, it would also be beneficial if a professional were to be able to set a desired development time before a given roast so that they are not tied to monitoring the roast, and can undertake other tasks at the same time.

As aforementioned, implementations of the teachings of this disclosure can provide a table-top coffee-bean roaster that well suited for home roasting in a domestic environment. From a commercial perspective, to improve the appeal of coffee bean roasting apparatus of the type disclosed herein, it is beneficial for the cost of the component parts of the roaster to be carefully controlled and for savings to be identified, so that the roasting apparatus can be marketed at a price point that is more attractive to consumers, and more commercially viable for the coffee roaster manufacturer. Another factor of concern to the coffee roaster manufacturer is the typically limited amount of space within the casing of a coffee roaster.

Aspects of this disclosure have been devised with at least some of the foregoing issues in mind.

### SUMMARY

In one presently preferred implementation of the teachings of this disclosure there is provided apparatus for roasting coffee beans, the apparatus being as defined in claim 1.

An advantage of this implementation is that as the control system is capable of automatically determining when first crack occurs, users are relieved from having to manually attempt to determine when first crack occurs, and as a result no longer need to monitor a roast to determine when first crack has occurred. In one implementation, the control system of the roaster may be configured to signal to the user when first crack has occurred.

The control system may be operable to control the roaster to implement a roast profile. This is an advantageously simple way to control the roaster to roast beans. In an alternative arrangement, the roaster may be manually controlled. The control system may be operable to control the roaster to implement a roast profile that defines a development time for which the coffee beans are to be roasted once first crack has occurred.

The control system may be operable to determine that first crack has occurred when the temperature is above a threshold and the humidity is at a maximum. In another arrangement, the control system may be operable to determine that first crack has occurred when the temperature is above a threshold and the rate of change in humidity is at a maximum. The temperature threshold may generally be in the region of 190 degrees centigrade.

The roast profile may define a temperature in excess of said threshold at which the beans are roasted. The temperature defined in said roast profile may vary with time throughout the course of a roast. The roast profile may define a speed at which the fan is operated.

In a preferred implementation, the humidity sensor may be remote from an outlet of the roast chamber. This arrangement allows a less expensive humidity sensor to be employed as it is no longer necessary for the sensor to be capable of withstanding the effect of high temperature air from the roast chamber. In one implementation the outlet may direct heated air through a passageway fluidly coupling said outlet to an exhaust from said apparatus, and the humidity sensor may be coupled by a sample pipe to said passageway. The sample pipe may be of a material having a high thermal conductivity. The humidity sensor may be mounted on a printed circuit board located remotely from an outlet of the roast chamber. The control system may be mounted on said printed circuit board. In one implementation, the fan may be configured to pass air that has not been heated by the heater over the printed circuit board to cool the printed circuit board.

The control system may comprise a processor and memory. The memory may be programmed with user selectable roast profiles. This arrangement is advantageous as it allows a user who is unfamiliar with the process of green bean roasting to select appropriate roast profiles.

In one envisaged arrangement, the control system may be configured to stop a roast once the development time post first crack has expired. The apparatus may comprise a CO2 sensor operable to generate signals that are representative of the concentration of CO2 in the heated air that has passed through the roast chamber. The control system may be operable to determine that second crack has occurred in response to signals from said CO2 sensor. The control system may be operable to determine that second crack has occurred when the signals from said CO2 sensor indicate that the concentration of CO2 in the heated air that has passed through the roast chamber has exceeded a threshold.

In one arrangement the control system may be operable to stop roasting beans in said roast chamber responsive to a determination that second crack has occurred. This arrangement is advantageous as it reduces the likelihood of the roast continuing to a potentially dangerous point where the roasted beans start to ignite.

In the preferred arrangement the fan and roast chamber may be configured and arranged so that coffee beans located in the chamber circulate generally horizontally about the periphery of the chamber when the fan is operated to pass heated air through the chamber.

In one arrangement, the control system may be operable to control the fan to pass air though the roast chamber at a first rate within a first range of airspeeds to circulate the beans as they roast, and at a second rate within a higher range of airspeeds than the first range to lift the beans towards and through an outlet of said roast chamber. This arrangement provides an elegantly simple and safe mechanism for removing roasted beans from the roast chamber for dispense to a user.

The fan may be arranged to draw air through the roast chamber. The apparatus may further comprise a secondary fan arranged to draw heated air from said passageway through said sample tube towards said humidity sensor. In another arrangement the fan may be arranged to blow air through the roast chamber.

In preferred implementations, the said roasting apparatus may include an enclosure, and said fan may be configured to draw air into the roasting apparatus through an intake and circulate the air over an internal surface of the enclosure before the air is passed towards the heater. This arrangement is advantageous as the cooler air drawn into the intake and passed over the internal surface of the enclosure helps to make an external surface of the enclosure cooler to the touch, thereby reducing the risk of injury if a user should happen to touch the outside of the casing.

The apparatus may comprise a user interface for enabling a user to control the apparatus. The control system may include a short range wireless transceiver for wireless receiving operating instructions from a remote computing resource. The remote computing resource may be associated with a code reader that is operable to read encoded roast profiles, and the remote computing resource may be operable to decode read encoded roast profiles to generate roast profile instructions for transmission to said control system. The encoded roast profile may comprise a bar code or QR code, and said reader may comprise a QR code or bar code reader. The encoded roast profile may be provided on packaging for a measure of green beans that are to be roasted in the roasting apparatus. This arrangement is advantageous as it readily provides an inexperienced user with the ability to program a roast profile that is suitable for a particular batch of green coffee beans into the control system of the apparatus.

In another implementation of the teachings of the invention, there is provided an apparatus for automatically roasting coffee beans, the apparatus comprising a humidity sensor operable to generate signals representative of the humidity of heated air used to roast a measure of green coffee beans; a user interface for enabling a user to set a desired development time, and a control system operable in response to signals from said humidity sensor to determine that first crack has occurred, and to automatically stop roasting said coffee beans once a period of time post said determined first crack has expired, said period of time post said determined first crack being equal to said desired development time.

In yet another implementation of the teachings of the invention there is provided a method for automatically roasting coffee beans, the method comprising the steps of: enabling a user to set a desired development time for a roast; monitoring the humidity of heated air used to roast a measure of green coffee beans during a roast, determining in response to signals from said humidity sensor when first crack has occurred, and automatically stopping the roast of said coffee beans once a period of time post said determined first crack has expired, said period of time post said determined first crack being equal to said desired development time.

In another implementation of the teachings of this disclosure, there is provided roasting apparatus for roasting coffee beans, the apparatus comprising: a roast chamber in which a supply of coffee beans can be received for roasting; a heater for heating beans within the chamber during a roast; a humidity sensor operable to provide signals that are representative of the humidity of the air within the roast chamber; and a control system operable to control the apparatus, wherein said control system is operable to receive signals from said humidity sensor and provide an indication of the humidity of the air within the roast chamber. This arrangement is advantageous as it makes it easier for a user to monitor the humidity within the roast chamber whilst a roast is taking place. The indication provided by the control system could be a graphical display of humidity over time.

In another implementation there is provided a humidity monitoring module as defined in claim 33. This module is well suited for retro-fitting to existing coffee bean roasting apparatus. The output interface could be a wired interface (e.g. USB) or wireless interface (such as a Bluetooth™ interface). The sensor and interface could be provided within an enclosure.

Other advantages and aspects of the heat transfer system disclosed herein will be apparent from the detailed description provided below.

### BRIEF DESCRIPTION OF THE DRAWINGS

The teachings of this disclosure, and arrangements embodying those teachings, will hereafter be described by way of illustrative example with reference to the accompanying drawings, in which:

FIGS. 1, 2 and 3 are, respectively, an end elevation, a top plan view and a side elevation of roasting apparatus as disclosed herein;

FIG. 4 is a schematic representation of the components of the apparatus depicted in FIGS. 1 to 3;

FIGS. 5 and 6 are schematic representations of different air flow pathways through the apparatus of the preceding figures;

FIG. 7 is a schematic chart of absolute humidity versus time for an illustrative roast profile;

FIG. 8 is a flowchart depicting an illustrative operating procedure for a control system for roasting apparatus of the type disclosed herein;

FIG. 9 is a cut-away perspective view of roasting apparatus of the type disclosed herein;

FIG. 10 is another view of roasting apparatus of the type disclosed herein with part of the outer casing removed;

FIG. 11 is a schematic representation of the components of another roasting apparatus of the type disclosed herein; and

FIG. 12 is a flowchart depicting a modification of the operating procedure depicted in FIG. 8.

### DETAILED DESCRIPTION

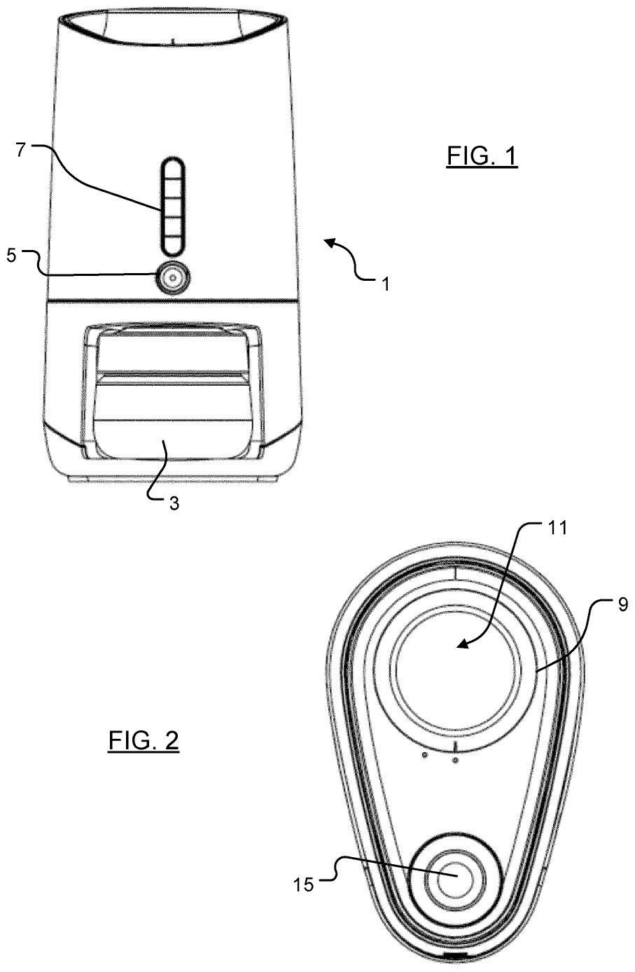

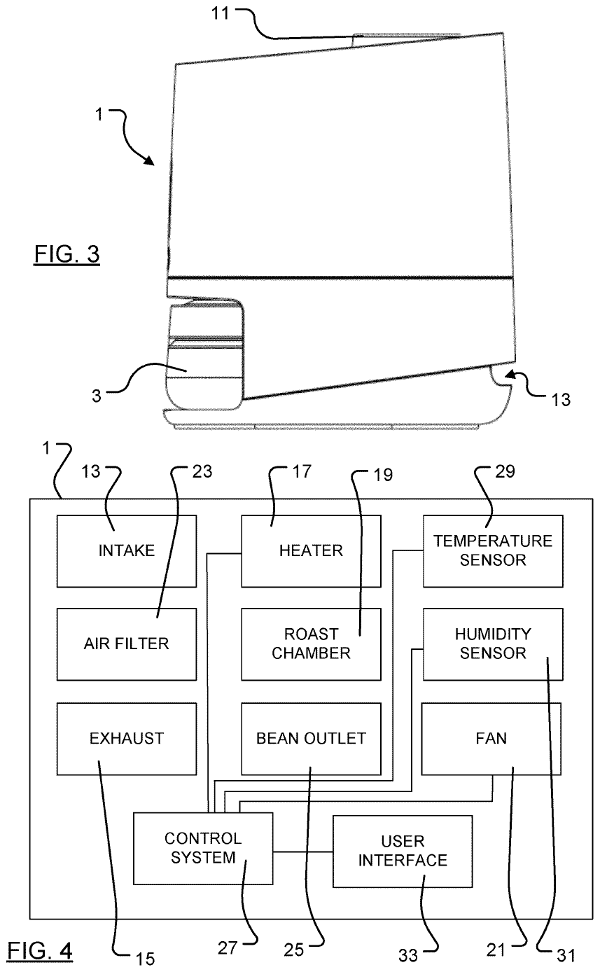

Referring to FIGS. 1 to 3, there is shown—respectively—an end elevation, a top plan view and a side elevation of roasting apparatus 1 according to a preferred implementation of the teachings of this disclosure.

The roasting apparatus 1 has a generally triangular footprint, and includes a recess at the narrower end for receiving a receptacle 3 for roasted beans. The roasting apparatus 1 includes an on/off switch 5 and a user interface 7 consisting, in this illustrative example, of a plurality of buttons. In the preferred arrangement, the roaster is capable of wirelessly communicating, for example by means of a short-range wireless communications protocol (such as Bluetooth™ or ZigBee™) with a computing resource, such as a laptop, tablet or mobile telephone, running an application that enables a user to operate and program the roasting apparatus 1.

Green coffee beans can be introduced into a roasting chamber within the apparatus by means of a port 9 on the top of the apparatus 1, which port in this instance is closed by a removable cap 11. In the preferred arrangement, the cap can be rotated between a first position where the cap can be removed to allow the apparatus to be loaded with beans for roasting, and a second position where the cap is locked and cannot be removed. As a safety feature, the roasting apparatus may be configured so that the roaster can only be operated to roast beans when the cap is in the aforementioned second position. The apparatus may further be configured so that once a roast has commenced, the cap cannot be rotated from the second position to the first until the roast has finished, and—optionally—the roasting apparatus has cooled.

In a similar manner to the roasting apparatus disclosed in European U.S. Patent No. 2635141, United Kingdom Patent No. 2485073 and U.S. Pat. No. 9,545,169 (the contents of each of which are incorporated herein as though they were each included in their entirety in this disclosure), air is drawn into the roasting apparatus 1 and heated. The heated air then passes through a roasting chamber within the apparatus that is configured so that the heated air circulates green coffee beans received within the chamber, and roasts them whilst they are circulated. In the preferred arrangement, air is drawn into the roasting apparatus via an intake 13 towards the base of the apparatus, and expelled from an exhaust 15 on the top of the apparatus. In a particularly preferred implementation, air at ambient temperature may be drawn into the apparatus 1 and up inside the casing before being heated and passed through the roasting chamber. In this way, relatively cooler air drawn into the roaster for heating helps to keep the casing of the roaster cool.

Referring now to FIG. 4, an illustrative roasting apparatus 1 according to the present disclosure has a number of different components arranged within the apparatus. As aforementioned, air is drawn into the apparatus 1 via the intake 13 for heating by a heater 17 (typically an electric heater) before being passed through a roast chamber 19 in which green beans are placed for roasting. A fan 21 is operable to draw air into the intake and pass heated air through the roast chamber 19. Heated air circulates the beans round the chamber 19 whilst they are roasting, before the hot air passes through an outlet of the chamber to the aforementioned exhaust 15 in the casing via an air filter 23 which functions to remove any chaff that might be generated during the roasting process. Once the beans have been roasted, they pass through the outlet of the roasting chamber and via a bean outlet 25 into the aforementioned receptacle 3. In one envisaged implementation, the fan 21 may be operated at a first lower speed to circulate beans as they are roasted in the roast chamber, and at a second higher speed to lift roasted beans out of the roast chamber 19 once the roast has been completed. The roast chamber 19 may be generally frustoconical to facilitate circulation of the beans as they are roasted.

The apparatus 1 includes a control system 27 that includes a processor and memory. The control system 27 is coupled to the heater 17 and the fan 21 and is capable of turning them on and off as required (or otherwise interacting with them, for example by varying the wattage and/or RPM respectively to adjust the temperature of the heated air). The control system 27 is coupled to a temperature sensor 29 and a humidity sensor 31. The temperature sensor 29 is configured and arranged to generate signals representative of the air temperature within the roasting chamber, and the humidity sensor 31 is configured and arranged to generate signals that are representative of the absolute humidity of the heated air as it passes from the roast chamber 19 towards the exhaust 15. The temperature and humidity signals are passed from the respective sensors to the processor of the control system and are used by the processor to monitor the implementation of a roast profile for a given roast.

A user interface 33 is coupled to the control system and is configured to enable a user of the roasting apparatus to operate the apparatus, in particular to implement a roast profile for a given roast. As aforementioned, the user interface may include buttons on the apparatus that implement certain functions, as well as a short-range wireless interface that permits a user interacting with a software application on a suitable computing device (such as a tablet, laptop or mobile telephone) to instruct the processor in the control of the roasting apparatus.

In one envisaged implementation, the memory may be pre-programed with roast profiles that a user can select. Alternatively, or additionally, a user may be able to define their own customised roast profile. In another envisaged implementation, batches of green coffee beans may be associated with a code (such as a barcode or QR code™) provided on packaging for the beans that a user can scan (for example, using the camera of a mobile telephone) to generate instructions for implementing a roast profile for the batch of beans within the packaging. The user interface 33 may also be controllable by the processor to provide the user with information concerning the progress of an initiated roast.

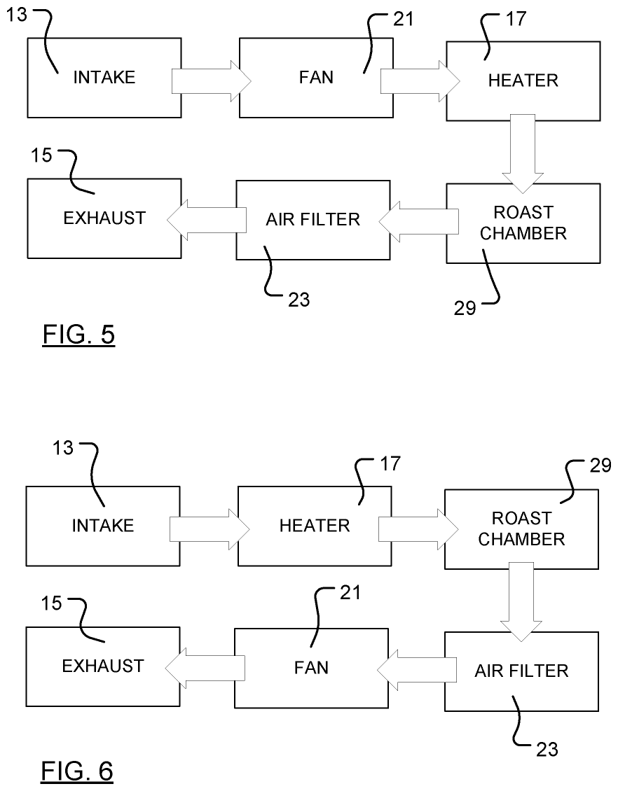

In one envisaged implementation of the teachings of this disclosure the fan 21 may be arranged, as shown in FIG. 5, to drive air from the intake 13 through the heater 17 and into the roast chamber 19. In another envisaged arrangement, the fan 21 could be arranged between the heater and the roast chamber. In yet another envisaged arrangement, as shown in FIG. 6, the fan 21 may be arranged to draw air through the roast chamber 19. In general terms, the fan operates to generate a pressure difference between the roast chamber and ambient, be that a positive pressure difference (in circumstances where the fan blows air into the roast chamber) or a negative pressure difference (in circumstances where the fan draws air from the roast chamber). Irrespective of which arrangement is chosen, it is preferred for the roasting apparatus components to be arranged so that cooler ambient air that has not been heated is passed around the inside of the casing, to help cool the casing. It is also preferred for the control system to be arranged so that relatively cooler air that has not been heated is passed over the control system to help cool the components thereof.

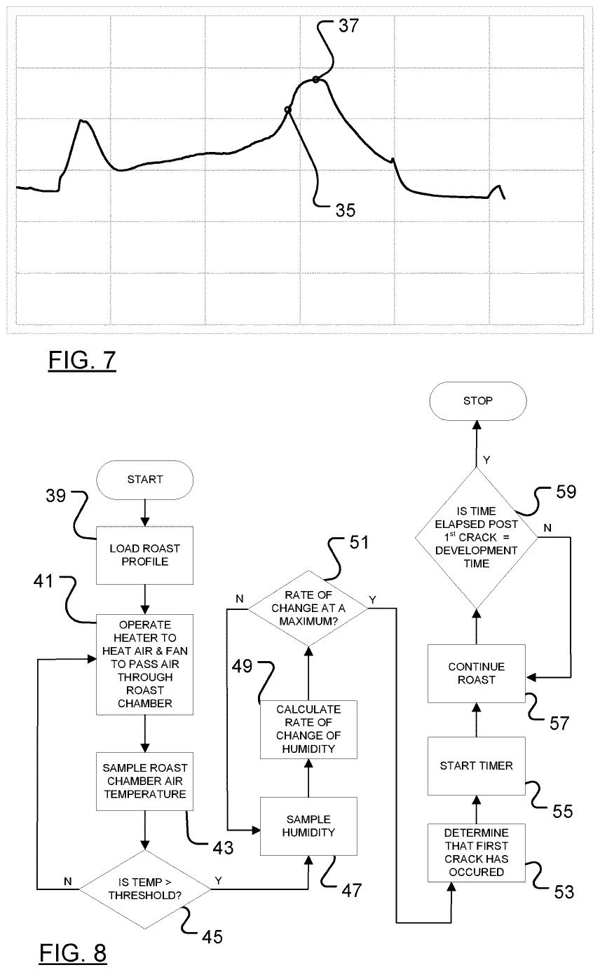

FIG. 7 is a chart that depicts variations in absolute humidity of the air that has passed through the roasting chamber versus time for an illustrative roast. As shown, at the start of the roast (towards the left of the chart) the absolute humidity increases as the temperature within the roast chamber increases and the relatively wet green coffee beans in the roast chamber are heated. Once the green beans have dried, the absolute humidity drops and continues at a roughly constant level as the roast progresses and the temperature within the roast chamber continues to rise. Once the temperature within the roast chamber exceeds a threshold, the aforementioned “first crack” starts to occur and the humidity increases as the green beans split open and release any moisture within the bean. As all the beans undergo “first crack” the humidity continues to rise to a maximum, before it begins to reduce once the moisture within the cracked beans has been driven off. In one implementation of the teachings of this disclosure, “first crack” may be determined to have occurred once the temperature within the roast chamber has exceeded the threshold and the rate of change in absolute humidity reaches a maximum (indicated by reference numeral 35 in FIG. 7). In another implementation, “first crack” may be determined to occur when the temperature within the roast chamber has exceeded the threshold and the absolute humidity reaches a maximum (indicated by reference numeral 37 in FIG. 7).

In both cases the threshold temperature is set to be in the region of 190 to 210 degrees centigrade, preferably in the region of 195 degrees centigrade, as green coffee beans do not crack below this temperature and hence any maxima in humidity or the rate of change of humidity cannot be attributed to the occurrence of the first crack. In this context, it will be understood by persons of skill in the art that it is the temperature of the air immediately surrounding the roasting beans that governs whether, and when first crack occurs. If the air temperature were to be measured downstream from the roasting chamber towards the exhaust, for example, then first crack may appear to occur at a temperature below or outside of 190 to 210 degrees centigrade (because the air existing the roast chamber has cooled before the temperature is measured), but the air temperature that the beans are exposed to will nevertheless be in excess of 190 degrees centigrade. In the roasting apparatus herein disclosed, the threshold is set as aforementioned because the temperature of the air within the roast chamber is sampled, but it is within the scope of the present disclosure for other thresholds to be set in circumstances where the air temperature is measured elsewhere (or indeed for the air temperature to be inferred by measuring the temperature of something else, for example an outside surface of the roast chamber).

As mentioned above, an important indicator for the degree of roast and flavour is the “development time”, and is equal to the amount of time the roast continues after the first crack has occurred. The development time is often expressed as a ratio of the development time to the total roast time, referred to in the art as “the development time ratio”. In envisaged implementations of the teachings of this disclosure, a user is enabled to input a desired development time into the control system or select a desired development time, and the control system is enabled, as will now be described, to automatically cease the roast once the user input or selected development time has expired.

FIG. 8 is a flow chart depicting the steps in an illustrative control process implemented by the control system, in particular by software executed by the processor of the control system. In a first step 39 of the process, the processor loads a roast profile—which may be a roast profile selected by a user from a number of roast profiles stored in memory, a custom roast profile input by a user, or a roast profile defined by a decoded code on packaging associated with the beans that are to be roasted. In one implementation, the roast profile defines at least the length of the roast, the development time (or development time ratio) and a temperature that the beans are to be roasted at (which may be constant, or may vary as the roast progresses). In another envisaged arrangement, the roast profile may simply define the length of the roast, and a temperature that the beans are to be roasted at (which may be constant, or may vary as the roast progresses).

Once the roast profile has been loaded, the processor switches on the heater and the fan in step 41, and starts to monitor the temperature within the roast chamber in step 43 based on signals from the temperature sensor. The heater functions to heat air to the roast temperature defined in the roast profile, and the fan operates to pass that heated air through the roast chamber to roast green beans located therein (and optionally to circulate the beans as they are roasted). The temperature in the roast chamber is monitored and a determination is made in step 45 as to whether the temperature in the roast chamber is above or below the threshold temperature at which “first crack” could potentially occur. If the temperature within the roast chamber is below the threshold, the heater and fan continue to operate to raise the temperature within the roast chamber.

If, on the other hand, the temperature within the is determined to be above the threshold temperature at which first crack could occur, the processor begins—in step 47—to monitor the absolute humidity of the air that has passed into the roast chamber based on signals from the humidity sensor, and to calculate the rate of change in absolute humidity in step 49. The processor then determines in step 51 whether the rate of change in absolute humidity has reached a maximum by comparing a current measurement with preceding measurements. If the rate of change is not at a maximum, the processor continues to monitor the absolute humidity and determine the rate of change.

If the rate of change in absolute humidity is determined in step 51 to be at a maximum, the processor determines that first crack has occurred in step 53 and starts a timer at step 55. The processor may indicate to a user, at this stage, that first crack has occurred. The roast is continued in step 57 and a determination is made in step 59 whether the time elapsed since first crack was determined to have occurred is equal to the development time specified in the roast profile.

If the time elapsed since first crack is determined to be equal to the development time set in the roast profile, then the roast is stopped and the heater is turned off. The fan may also be switched off at this point, or may continue to be operated to assist with cooling of the roasted beans in the chamber. It may also be operated at a higher rate than previously to lift the roasted beans out of the roast chamber and into the bean outlet, and ultimately the aforementioned receptacle. In another envisaged arrangement, the beans could be otherwise ejected from the roast chamber (for example, by opening a door in the roast chamber). If the time elapsed since first crack is, on the other hand, not equal to the development time, then the roast is allowed to continue in step 57.

In another contemplated arrangement, the control system may—instead of starting a timer and stopping the roast once that timer has reached the development time—simply signal to the user that first crack has occurred, for example by sounding an alarm or illuminating an indicator light.

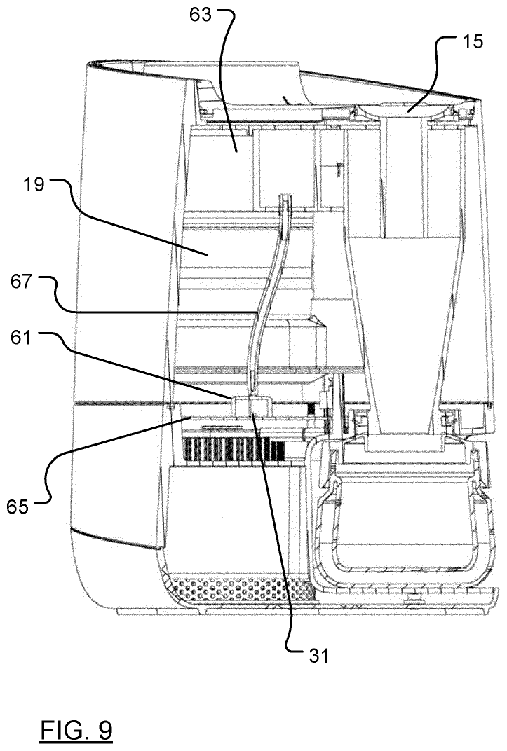

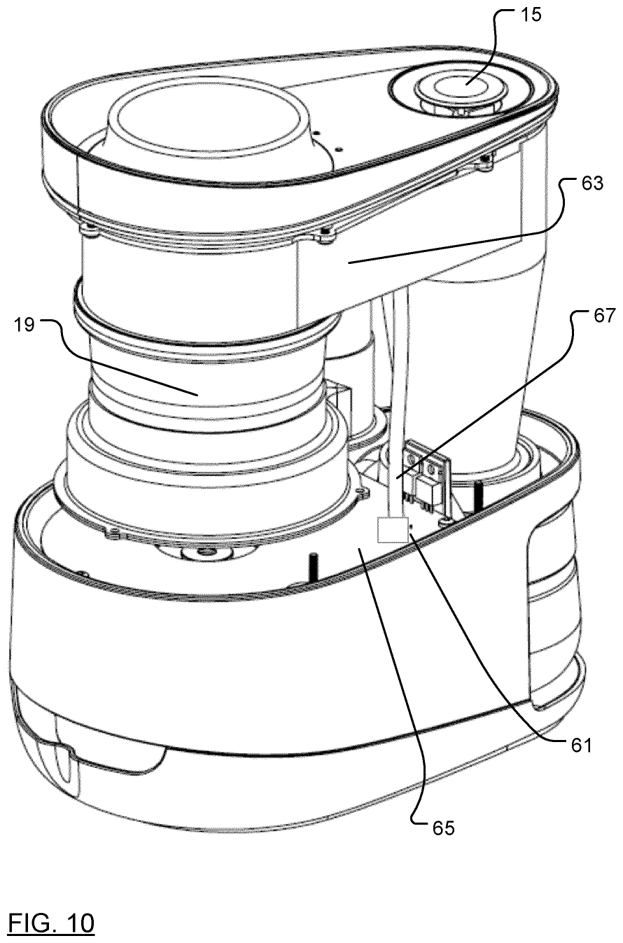

Referring now to FIGS. 9 and 10 of the accompanying drawings, whilst it is envisaged above for the humidity sensor to be provided at the outlet of the roast chamber so that the absolute humidity of the air passing through the chamber can be measured, it is the case that the temperature of that air during a roast will likely be in excess of 190 degrees centigrade, which means that the humidity sensor will need to be capable of withstanding such temperatures.

Humidity sensors that can withstand such temperatures are available, but they are expensive and it would be advantageous if an alternative less expensive sensor could be employed that works with air at a lower temperature.

With this in mind, it is envisaged—as shown in FIGS. 9 and 10—for the humidity sensor 31 to be located at a position remote from the outlet 63 of the roast chamber. The humidity sensor in this implementation of the teachings of this disclosure is provided within a housing 61 that is mounted on a printed circuit board 65, optionally along with the other components of the control system 27. The housing is coupled to the outlet 63 by a sample pipe 67 which allows a small amount of air to be bled from the air passing through a passageway extending from the outlet towards the exhaust 15. The air bled from the heated air passing through the passageway from the outlet towards the exhaust 15 cools as it passes through the sample pipe 67 (which may be configured to enhance this process, for example by being formed of a material that is a good conductor of heat) before it impinges upon the humidity sensor 31, and as a result the humidity sensor 31 does not need to be as robust (and hence as expensive) as one that can operate in the higher temperature air passing from the outlet of the roast chamber to the exhaust.

In the implementation of FIG. 4, the positive pressure within the roast chamber is sufficient to cause air to pass down the sample pipe 67. In the implementation of FIG. 5, a smaller secondary fan may be employed to draw air into the sample pipe from the outlet of the roast chamber.

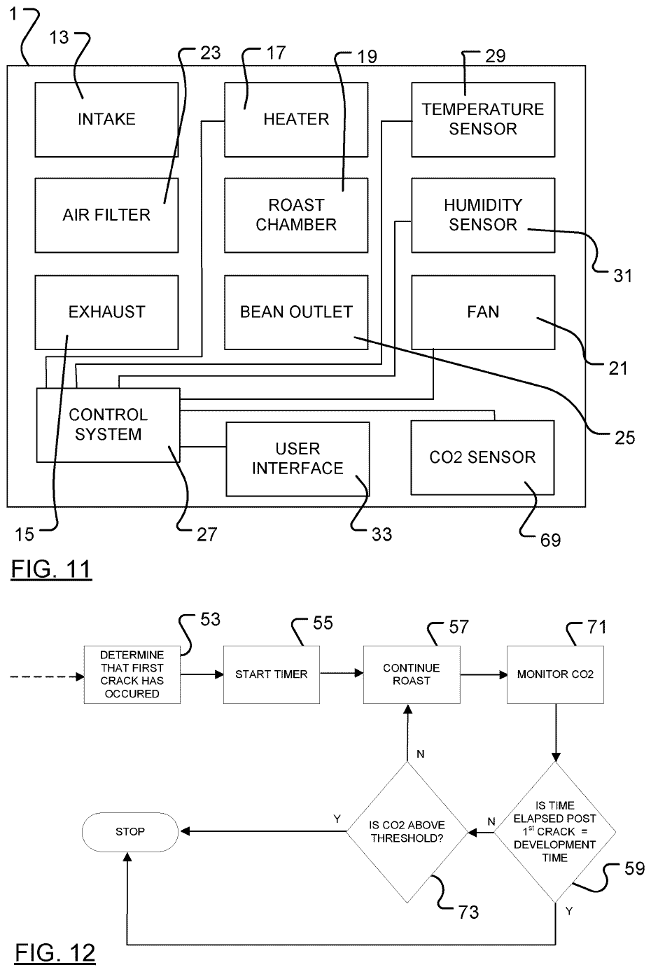

Referring now to FIGS. 11 and 12 of the accompanying drawings, there is depicted another implementation of roasting apparatus according to the present disclosure. The apparatus depicted in FIG. 11 differs from that shown in FIG. 4 by virtue of the inclusion of a CO2 sensor 69. All the other components are the same, and for brevity will not be described in detail.

The CO2 sensor 69 may be located in the roast chamber, in the outlet from the roast chamber, in the passageway leading from the outlet to the exhaust, or alternatively may be located alongside the humidity sensor on the printed circuit board 65. As aforementioned, in the latter part of a dark roast, the beans will eventually reach a state known as the “second crack”, when the coffee beans become oily. If roasting continues long after the second crack (the exact amount of time varying with the type of bean and the temperature of the roast), the beans will eventually start to ignite.

Second crack and subsequent progression towards ignition is characterised by an increase in carbon dioxide, and the CO2 sensor 69 functions to reduce the likelihood of the beans igniting by detecting the increase in CO2 associated with the second crack, thereby enabling the control system to stop the roast at or shortly after second crack and in any event before the beans can ignite.

FIG. 12 is a flow chart depicting the steps in an illustrative modification of the control process depicted in FIG. 8. In this illustrative process the processor receives signals from the CO2 sensor 69 in step 71, and if the elapsed time post first crack is determined not to have reached the development time, a check is made in step 73 to determine whether the measured CO2 levels are above a threshold which indicates that second crack has occurred (or is about to occur). If, in step 73, the measured CO2 is determined to be above the threshold, the roast is stopped. The roast is only allowed to continue in step 57 if the time post first crack has not reached the development time and the measured CO2 level is less than the threshold. In this way, the likelihood of the beans igniting post second crack can be reduced, in particular by reducing the chance of the beans igniting even if a user should set an excessively long development time.

It will be appreciated that whilst various aspects and embodiments of the present disclosure have heretofore been described, the scope of the disclosure is not limited to the particular arrangements set out herein and instead extends to encompass all arrangements, and modifications and alterations thereto, which fall within the scope of the appended claims. For example, in the processes depicted in FIGS. 8 and 12, the processor may continually monitor humidity levels and/or CO2 levels from the outset, rather than only starting to monitor such levels partway through the roast. It is also envisaged for other parameters to be monitored in a neural network to automate the roasting of green coffee beans. In another envisaged arrangement, the fan could be positioned between the roaster and the air filter. In yet another envisaged arrangement, the humidity sensor could be configured to measure relative humidity instead of (or in addition to) absolute humidity.

In addition to the foregoing, it should also be noted that whilst in one embodiment the roasting apparatus disclosed herein is operable to automatically cease the roast once a predefined development time has occurred, this is not essential. It is envisaged, for example, for the apparatus to merely notify the user that first crack has been determined to have occurred, and leave the user to manually control the roaster—inter alia to continue to roast for a desired development time. It will be apparent that in such an arrangement it will not be necessary for the roast profile to include a development time, or for the control system to set a development time when roasting to that profile.

It should also be noted that whilst the accompanying claims set out particular combinations of features described herein, the scope of the present disclosure is not limited to the particular combinations hereafter claimed, but instead extends to encompass any combination of features herein disclosed.

In addition, whilst embodiments of the present invention have been described above in the context of software modules that are executable by a processor, it should be noted that the scope of the present disclosure is not limited to an implementation of the teachings of the disclosure in software. Rather, the skilled person will immediately appreciate that the functionality described herein may equally be implemented in hardware (for example, by means of a plurality of application specific integrated circuits (ASICS)) or, indeed, by a mix of hardware and software.

Finally, it should be noted that any element in a claim that does not explicitly state “means for” performing a specified function, or “steps for” performing a specific function, is not to be interpreted as a “means” or “step” clause as specified in 35 U.S.C. Sec. 112, par. 6. In particular, the use of “step of” in the claims appended hereto is not intended to invoke the provisions of 35 U.S.C. Sec. 112, par. 6.

1-34. (canceled)

35. An apparatus for roasting coffee beans, the apparatus comprising:
a roast chamber in which a supply of coffee beans can be received for roasting;
a heater for heating air;
a fan for passing heated air through the roast chamber to roast coffee beans received therein;
a humidity sensor operable to provide signals that are representative of a humidity of the heated air that has passed through the roast chamber;
a temperature sensor operable to provide signals that are representative of an air temperature within the roast chamber; and
a control system operable to control the apparatus, wherein said control system is operable to determine that first crack has occurred in response to signals from said humidity sensor and said temperature sensor.

36. The apparatus according to claim 35, wherein the control system is operable to control the apparatus to implement a roast profile, said roast profile defining a development time for which the coffee beans are to be roasted once first crack has occurred.

37. The apparatus according to claim 35, wherein said control system is operable either to determine that first crack has occurred when the air temperature is above a threshold and the humidity is at a maximum, or to determine that first crack has occurred when the air temperature is above a threshold and a rate of change in humidity is at a maximum.

38. The apparatus according to claim 36, wherein said roast profile defines a temperature in excess of a threshold at which the coffee beans are roasted and/or a speed at which the fan is operated.

39. The apparatus according to claim 35, wherein said humidity sensor is remote from an outlet of the roast chamber, said outlet directing heated air through a passageway fluidly coupling said outlet to an exhaust from said apparatus, said humidity sensor being coupled by a sample pipe to said passageway.

40. The apparatus according to claim 39, wherein said humidity sensor is mounted on a printed circuit board located remotely from the heater.

41. The apparatus according to claim 40, wherein said fan is configured to pass air that has not been heated by the heater over the printed circuit board to cool the printed circuit board.

42. The apparatus according to claim 35, wherein said control system comprises a processor and memory, said memory being programmed with user selectable roast profiles.

43. The apparatus according to claim 35, wherein the control system is configured to stop a roast once a development time post first crack has expired.

44. The apparatus according to claim 35, comprising a CO2 sensor operable to generate signals that are representative of a concentration of CO2 in the heated air that has passed through the roast chamber, said control system being operable to determine that second crack has occurred in response to signals from said CO2 sensor indicating that the concentration of CO2 in the heated air that has passed through the roast chamber has exceeded a threshold.

45. The apparatus according to claim 44, wherein said control system is operable to stop roasting coffee beans in said roast chamber responsive to a determination that second crack has occurred.

46. The apparatus according to claim 35, wherein the fan and roast chamber are configured and arranged so that coffee beans located in the roast chamber circulate generally horizontally about a periphery of the roast chamber when the fan is operated to pass heated air through the roast chamber.

47. The apparatus according to claim 46, wherein said control system is operable to control the fan to pass air though the roast chamber at a first rate within a first range of airspeeds to circulate the coffee beans as they roast, and at a second rate within a higher range of airspeeds than the first range to lift the coffee beans towards and through an outlet of said roast chamber.

48. The apparatus according to claim 35, wherein said fan is arranged to draw air through the roast chamber, or blow air through the roast chamber.

49. The apparatus according to claim 48, wherein said apparatus includes an enclosure, said fan being configured to draw air into the apparatus through an intake and circulate the air over an internal surface of the enclosure before the air is passed towards the heater.

50. The apparatus according to claim 35, wherein said control system includes a short range wireless transceiver for wireless receiving operating instructions from a remote computing resource.

51. The apparatus according to claim 50, wherein said remote computing resource is associated with a code reader that is operable to read encoded roast profiles, and said remote computing resource is operable to decode read encoded roast profiles to generate roast profile instructions for transmission to said control system.

52. The apparatus according to claim 51, wherein an encoded roast profile is provided on packaging for a measure of green coffee beans that are to be roasted in the apparatus.

53. A humidity monitoring module for coffee bean roasting apparatus, the module comprising:
a humidity sensor for generating signals representative of air humidity;
an output interface coupled to the humidity sensor for outputting said signals; and
a sample tube configured to be coupled to a roast chamber of the coffee bean roasting apparatus or to a passageway leading from an outlet of the roast chamber towards an exhaust of the coffee bean roasting apparatus, said sample tube being configured to direct air from said roast chamber or said passageway, respectively, to said humidity sensor to enable the humidity sensor to generate signals representative of the air humidity of that air and the module to output those signals via said output interface.

54. A roasting apparatus for roasting coffee beans, the apparatus comprising:
roast chamber means in which a supply of coffee beans can be received for roasting;
heater means for heating coffee beans within the roast chamber means during a roast; and
humidity sensing means operable to provide signals that are representative of a humidity of air within the roast chamber means; and control system means operable to control the apparatus, wherein said control system means is operable to receive signals from said humidity sensing means and provide an indication of the humidity of the air within the roast chamber means during the roast.
